(19) United States
(12) Patent Application Publication
(10) Pub. No.: US 2008/0029746 A1
(43) Pub. Date: Feb. 7, 2008

(54) Device

(75) Inventors: Gordon Robin Bellamy Creed, Cheshire (GB); James Robin Creed, Cheshire (GB)

Correspondence Address: SUZANNAH K. SUNDBY;SMITH, GAMBRELL & RUSSEL, LLP, 1130 Connecticut Avenue, NW, Suite 1130, WASHINGTON, DC, 20036, US

(73) Assignee: ELECTRAFENCE LIMITED, Cheshire (GB)

(21) Appl. No.: 11/832,953

(22) Filed: Aug. 2, 2007

(30) Foreign Application Priority Data
Aug. 4, 2006 (GB) 061552.7

(51) Int. Cl. B25B 25/00; A01K 3/00; E04H 17/20; B21F 9/00

(52) U.S. Cl. 256/10; 242/410; 254/199; 256/23

(57) ABSTRACT

The invention relates to an improved design of wire tensioner for use in electric wire fences. As well as attaching a wire to a fence post, and tensioning the wire, the device also insulates the wire from the metal post. The device comprises an insulating means or body which has an engagement face for engaging with internal surface of a fence post and a spring for applying a tensioning force to the wire. Any changes in the length of the wire due to ambient temperature variation can be absorbed by the spring, thus minimising maintenance adjustments of the wire tension. The spring may also be used to press the engagement face against the surface of the fence post, and therefore hold the device in position. The present invention also provides for installing the (wire tensioner) devices inside a fence post (which is fitted with a cover) and which contains the high voltage (HV) and earth wire connections.

### BACKGROUND OF THE INVENTION

1. Field of the Invention

The present invention relates to a device for use in attaching a wire to a fence post, tensioning the wire, and/or insulating (at least a part of) the wire from the fence post. The device may be used with an electric security fence in order to simplify the construction of such fence.

2. Description of the Related Art

Conventional electric security fences employ a grid of horizontal wires, from about ground level to 1 m above an associated perimeter fence, at a spacing of approximately 0.1 m. The wires can alternate between high voltage (HV) and earth and are located inside the associated perimeter fence, which is usually palisade or chainlink construction, using specially designed posts which are attached to the conventional perimeter fence posts.

The conventional apparatus used to attach the wires to the posts, and to connect up the wires to make the required electrical circuit, uses three different components duplicated at each end of the wire, and a wire tensioner, depending on the configuration (it requires separate hooks, insulators and wire clamps), and so is relatively complex. This complexity results in the apparatus being time consuming and consequently expensive to assemble.

### SUMMARY OF THE INVENTION

The main system currently being employed was developed by a New Zealand company, Gallagher Group, which uses a thick metal (S-shape) hook to connect a metal fence post with a plastic oval shaped plastic wire connector which insulates the fence wire from the post. The electrical connections are made directly to the wires beyond the plastic connectors.

According to a first aspect to the invention there is provided an (e.g. insulating) device comprising an (e.g. tension) means, for holding (or subjecting) an elongate element under (or to) tension, which (tension) means is located or housed (partly or fully) inside, or within, an (e.g. insulating) housing, or body, usually comprising an insulating material. The elongate element is preferably a (metal) wire. The tension means is suitably for tensioning such an element (e.g. wire). It may comprise a spring.

Optionally, the device also includes an (e.g. elongate element) attachment means, for attaching or securing the elongate element (such as a wire), preferably in the device, which means may comprise a wire gripper. The wire (attachment) means may also comprise means for connection to an electrical supply or source, such as a HV source.

Preferably the device comprises one or more of:

(a) connecting means suitable for making an electrical connection between the elongate member (e.g. wire) and a power or electrical (e.g. HV) source or supply;

(b) an (elongate element) attachment means, for securing or attaching the elongate element (e.g. wire);

(c) an (elongate element) tension means (e.g. a spring), for holding the elongate element under tension, for example tensioning the wire; and/or

(d) insulating means such as a housing or body, for insulating the elongate element (or wire), such as from a (e.g. metal) post or other (metal) member. The insulating means preferably encloses or surrounds (e.g. partially) the attachment means and/or the tension means.

Preferably, the connecting means, wire attachment means and/or wire tension means are partly (or fully) located, or housed, inside (or within) the housing or body, which may comprise insulating material, and which can constitute the insulating means. In use the insulating means can be (at least partly) located within or inside a (supporting) member, for example a (metal) post such as a fence post. Preferably, the invention allows the electrical (or power) source to be connected to the (wire) attachment means, rather than to the wire itself.

The design of apparatus to attach wires to a post, and to connect up the wires to make the required electrical circuit (and hence also the number of components that the apparatus comprises) can be determined by the need to provide four separate functions: electrical insulation; electrical connection; (wire) attachment; and (wire) tensioning.

The present invention aims to simplify the apparatus used to attach the wires to the (fence) post (or member), and to connect up the wires to make the required electrical circuit, and so seeks to reduce the number of components required. This can be achieved by combining more than one of the above-mentioned functions into a single component or device. The present invention aims to further simplify the construction of an electric security fence by using simpler (preformed) wiring inside the posts for the wiring connections.

The present invention can therefore replace the more expensive and cumbersome conventional system of (metal) hooks, (plastic pulley-like) insulators and wire clamps with a simple combined insulator, (wire) attachment and (wire) tensioner unit.

By locating one or more of the connection means, wire attachment means and/or wire tension means inside an insulating body (or at least partially enclosing one or more of these three means within a body or housing comprising insulating material), one or more of these means can be protected from the elements. This may reduce weathering (e.g. leading to rust or corrosion), and can reduce exposure to solar radiation, for example UV radiation. This may prolong the lifetime of the (wire) tension and/or (wire) attachment means. Indeed, the insulator means (e.g. housing) itself may benefit similarly because it may be (at least partially) located inside the (supporting) member (such as the metal fence post). This may also provide for increased security because, by being located inside the fence post, this may prevent, or at least mitigate, tampering or damage.

The invention therefore also contemplates an (e.g. supporting) member, such as a (fence) post, comprising one or more of the devices of the present invention, such as;

(a) connecting means for supplying a electrical power to, or making an electrical connection with, the elongate member;

(b) wire attachment means;

(c) wire tension means; and/or

(d) wire insulating means.

In addition, the invention contemplates a fence comprising at least one or two (e.g. substantially vertical) supporting members such as a fence post, and one or more (e.g. 2 or more) devices of the invention.

Preferably the (wire) tension means comprises a spring. This spring may be a metal and/or helical spring. However, preferably it comprises an elastomeric, deformable or compressible material, which can suitably be released or decompressed when tension or pressure has been released.

The device may be used to attach the element (e.g. a wire) to, and insulating it from, a member (e.g. fence post). The device can comprise an insulating means or body and, as the (wire) tension means, a spring.

Suitably the insulating body (or housing) comprises:

an engagement face for engaging with a (e.g. internal) surface of the member; and

a passage for the elongate element (wire) and/or a element (or wire) gripper in the insulating body, which passage can extend from the engagement face through the insulating body.

Preferably the spring is for applying a tensioning force to the element in a direction from the engagement face through said passage.

Also preferably, the tensioning means is a compression spring. The elongate element and compression spring are connectable together or arranged such that, in use, movement of the end of the elongate element that is connected to the compression spring in the direction from the engagement face through the passage results in compression of the compression spring.

The device can thus allow for the element to be at least insulated and tensioned, and can be of simple construction. It can thus be used to simplify the construction of a wire electric fence, and so may reduce its cost.

Preferably the device can further comprise a (removable) elongate element attachment means, such as a wire gripper, which can be placed within, but can be separable from, the insulating means (e.g. the housing) for gripping the wire. The attachment means (e.g. gripper) can thus be located (at least partially) inside the insulator means, for example in the passage in the insulator body. This has the further advantage that the wire can be gripped securely in the device, thus incorporating the feature of wire attachment and tensioning in a single device. According to this embodiment of the invention, the device can thus provide means for electrical insulation, wire attachment and wire tensioning.

Preferably, the tension means is a compression spring, and the elongate element and compression spring are connectable together or arranged such that the tension in the elongate element is controlled by the compression of the compression spring. As such, the device of the present invention allows the tension in the elongate element to be controlled without manual adjustment, for example as the length of the elongate element varies with temperature changes.

According to an embodiment of the invention, the device of the present invention is arranged such that an increase in compression force in the spring produces an increase in tension force in the elongate element, and an increase in tension force in the elongate element produces an increase in compression force in the spring. Similarly, a decrease in compression force in the spring produces an decrease in tension force in the elongate element, and a decrease in tension force in the elongate element produces a decrease in compression force in the spring.

Preferably, the compression spring and the elongate element are connectable together or arranged such that the compression force in the spring is proportional to the tension force in the elongate element. Accordingly, the compression force in the spring is directly related to the tension force in the elongate element. In some embodiments, the compression force in the spring is equal to the tension force in the elongate element.

The tension means, e.g. spring, can be formed integrally with the insulating means or body and/or is formed of the same material. This can provide the further advantage that the device (or at least the tension and insulating means) may be made from a single moulding.

The device can be arranged such that the spring force can be used to press the engagement face of the insulating means or body against the surface of the member with which the engagement face is for engaging, thereby securing the device in an operational position. This may mean that no separate component is required for fixing (in the prior art this is a metal hook) the device to a member, such as a fence post, thereby further simplifying the apparatus.

In a second aspect of the present invention there is provided a method of attaching an (e.g. metal) elongate element (e.g. a wire) to a (supporting) member (usually vertical) such as a (fence) post by locating a device for attaching, tensioning and/or insulating the element to a hole or aperture in the member (or fence post), such that the device is engaged with the member, and said elongate element and/or a (element or wire) attachment means pass through the hole in the fence post. This method can be simpler and more efficient than the conventional method of attaching wire to a fence post, because of the fewer number of components that may be needed.

The device referred to in the above method is any one of the devices herein described, and the device can engage with the member (e.g. fence post) by engaging the engagement face with an e.g. internal surface of the (fence post) surrounding the hole or aperture (in the fence post).

Preferred features and/or characteristics of one aspect of the invention are applicable mutatis mutandis to other aspects.

### DESCRIPTION OF THE DRAWINGS

The invention will now be described by way of non-limiting example only with reference to the accompanying figures in which like reference numerals refer to the same or similar components, and in which:

FIG. 1 shows a cross-section of a device according to one embodiment of the present invention;

FIG. 2 shows a cross-section of a device according to another embodiment of the present invention;

FIG. 3a shows a cross-section of a wire gripper for use in an embodiment of the present invention;

FIG. 3b shows a plan view of a washer with electrical tab connection for use with the wire gripper shown in FIG. 3a;

FIG. 4a shows a cross-section of a device according to one embodiment of the present invention including a wire gripper, with the spring in the device being in an uncompressed state;

FIG. 4b shows a cross-section of a device according to one embodiment of the present invention, including a wire gripper, with the spring in the device being in a compressed state; and

FIG. 5 shows a schematic view of an electric fence according to one embodiment of the present invention.

### DETAILED DESCRIPTION OF THE INVENTION

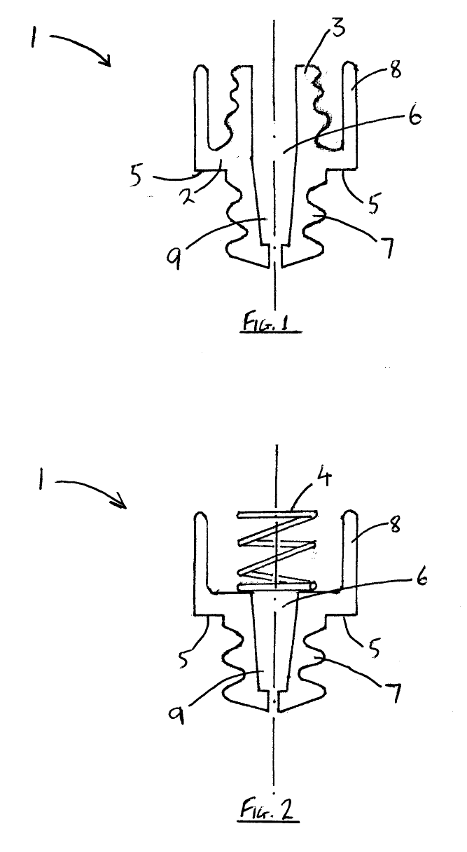

FIG. 1 shows a cross-section of a device (1) according to one embodiment of the present invention. The preferred embodiment of the device (1) is rotationally symmetric about the centreline shown in FIG. 1, and contains a passage (6) in a (wire) insulating means, insulating body (2). According to this embodiment, the passage (6) is part of an opening in the device (1) which is used to hold a wire attachment means, or gripper unit (10). The “ribbed” section (3) is a compressible spring which experiences compression as tension in a wire, being held and tensioned by the device (1), increases. In this way, the “ribbed” section (3) acts as a wire tensioning means, or spring, such that tension is applied to the wire by compression of the spring (3). In alternative embodiments, any other suitable type of compression spring (3, 4) could be used to act as a wire tensioning means. In the preferred embodiment, the tension force in the wire is proportional to (and in some embodiments equal to) the compression force in the spring (3).

Typically, the wire (or other elongate element) is held in tension by using one of the devices (1) according to the present invention at one, or both, ends of the wire. Any changes in the wire length, for example, from ambient temperature variation, can then be absorbed by the spring (3) of the device (1) at either or both ends of the wire, thus minimising maintenance adjustments of the wire tension. Thus, the device (1) allows the tension in the wire to be controlled (for example it allows the wire tension to be maintained substantially constant, or to be maintained above a pre-determined threshold) as the length of the wire changes, for example through a normal range of ambient temperatures, without requiring manual adjustment. Typically, such a range of ambient temperatures might be 0 degrees Celsius to 50 degrees Celsius. More typically, the range might be 5 degrees Celsius to 30 degrees Celsius. The temperature range could also include values above or below those given above.

In the embodiment shown in FIG. 1, the body (2) and the spring (3) are formed from a single elastomeric moulding, and are made from an insulating material. Also shown in this embodiment are a first shield portion (7) for surrounding and insulating a portion of a wire, and a second shield portion (8) for at least partially insulating a wire, a spring, and/or a wire gripper. Both the first (7) and second (8) shield portions may be formed from the same (elastomeric) moulding as the insulating body and the spring. The first (7) and second (8) insulating portions may be formed by any insulating medium, such as an elastomer, polythene, or propylene.

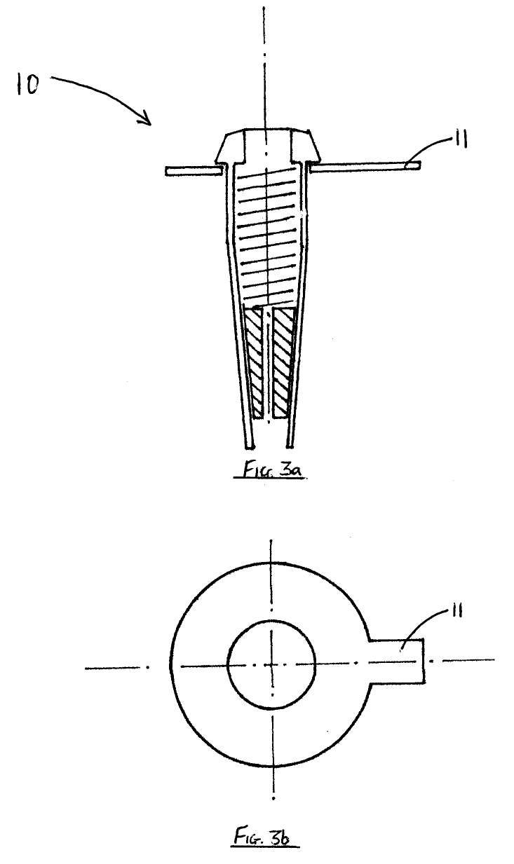

In some embodiments, the body (2), spring (3), first shield portion (7) and second shield portion (8) may be formed separately, and may not necessarily be formed of the same material. For example, in the embodiment shown in FIG. 2, the spring (4) is a more conventional helical type metal spring, which may or may not be formed integrally with the body (2).

One or more of the body (2), the spring (3), the first shield portion (7) and/or the second shield portion (8) may be made from a material which is resistant to degradation from (solar) ultra violet (UV) radiation.

In one embodiment of the invention, the passage (6) formed in the body (2) may be blocked when the device (1) is not in use. The passage (6) may therefore require breaking through in order to allow a wire and/or a wire gripper to pass through it.

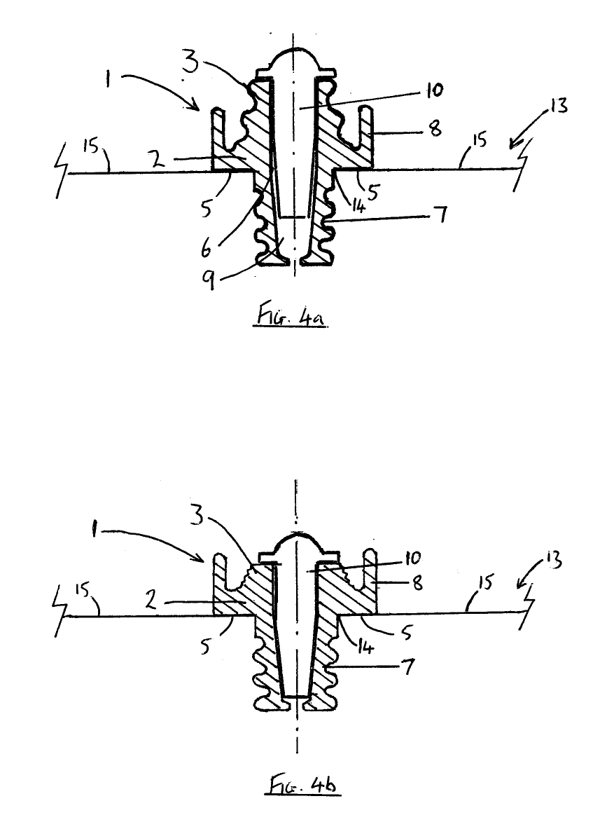

The embodiments shown in FIGS. 1 and 2 both comprise a frustro conical internal space (9) which is used to hold a wire gripper (10) for gripping a wire. The wire gripper (10) may be a conventional wire gripper, such as that shown in FIGS. 3a and 3b. In an embodiment of the invention which uses a wire gripper of the type shown in FIGS. 3a and 3b, in use the wire gripper (10) is inserted into the passage (6) of the device (1), as shown in FIGS. 4a and 4b.

The conventional wire gripper (10) shown in cross-section in FIG. 3a comprises an internal split cone section which can be made of hardened steel and serrated to provide a tight grip on a wire which is inserted into the split cone sections when that wire is put under tension. The wire gripper (10) shown in FIGS. 3a and 3b is further adapted so as to comprise a spade tab (11) for making the electrical connections between the relevant wires so that an electrical circuit can be created in an electric fence. The plan view of the wire gripper (10) shown in FIG. 3 shows a metal washer with a spade tab (11). Two or more such tabs (11) may be provided, if necessary, for example one for each (electrical) connector or connecting wire.

While the HV circuit is usually continuous (so that a cut wire anywhere can generate an alarm), the same requirement does not apply to the earth wire. Thus two tabs may be needed for connection to the earth wire (usually, inside the fence post).

Other embodiments of the invention can use or comprise different styles of wire gripper. These different styles of wire gripper can be conventional, non-conventional or adapted from a conventional wire gripper.

FIG. 4a shows a device (1) according to an embodiment of the invention similar to that shown in FIG. 1 assembled with a wire gripper (10) similar to that shown in FIGS. 3a and 3b. FIG. 4a shows a case where the spring (3) is uncompressed. This would occur, for example, if the wire being held by the wire gripper (10) were to be under very low tension or no tension at all.

FIG. 4b shows a state where the spring (3) in the device (1) is fully compressed. This could occur, for example, when the wire being held by the wire gripper (10) is shorter than, or has contracted from the length of, the wire being held by the wire gripper (10) shown in FIG. 4a. The change from the spring (3) being uncompressed in FIG. 4a to compressed in FIG. 4b could occur, for example, due to a change in the length of the wire caused by a change in ambient conditions, such as a temperature variation.

As shown in FIGS. 4a and 4b, the device (1) is arranged such that the compression force in the spring (3, 4) is directly applied, or transferred, to the wire as a tension force in the wire. As such, the compression force in the spring (3, 4) can directly affect the tension force in the wire i.e. a change in the compression force in the spring can lead to a (calculable) change in tension force in the wire, and vice versa. For example, as the tension force in the wire increases, or tries to increase, (for example due to a temperature variation), the spring (3, 4) compresses, and thus the compression force in the spring (3, 4) increases. Thus, the increase in tension in the wire can be controlled through the increase in compression force in the spring (3, 4). The spring constant of the spring (3, 4) can be chosen as appropriate to control the tension in the wire within a desired range, for example by considering the likely temperature variation that the wire will experience.

A portion of a member, here a fence post (13), is also shown in FIGS. 4a and 4b. The first shield portion (7) of the device (1) is shown as being inserted into a hole (14) in the fence post (13), such that the engagement face (5) of the device (1) is engaged with an inside face (15) of the fence post (13). Thus, the engagement face (5) ensures that the device (1) as a whole cannot move in the direction of the force applied to the device (1) due to tension force in the wire, thereby ensuring that the compression force in the spring (3, 4) is transferred to the wire.

As the conditions are varied such that the wire gripper (10) moves from the position shown in FIG. 4a to the position shown in FIG. 4b, the wire gripper (10) moves through the passage (6) in the device (1) so that in the fully compressed state shown in FIG. 4b, the outer face of the conical section of the wire gripper (10) is in contact with the inner face of the conical section (9) of the device (1). In other embodiments, the conical sections need not be in contact in the fully compressed state. Other embodiments may not require a conical section in either the wire gripper (10) or the device (1).

Typically, the spring (3) would be fully compressed when a force of about 20kg is applied. In operation, this applied force could come from tension in a wire being held by the wire gripper (10). Typical movement experienced by the wire gripper (10) when the spring (3) moves from the uncompressed state shown in FIG. 4a to the compressed state shown in FIG. 4b would be approximately 1 cm. In other embodiments, the spring (3) could be designed or selected so as to be fully compressed with an applied force of either more than 20 kg or less than 20 kg, and the movement of the wire gripper (10) experienced when the spring (3) moves from the uncompressed state to the fully compressed state could be more than one 1 cm or less than 1 cm.

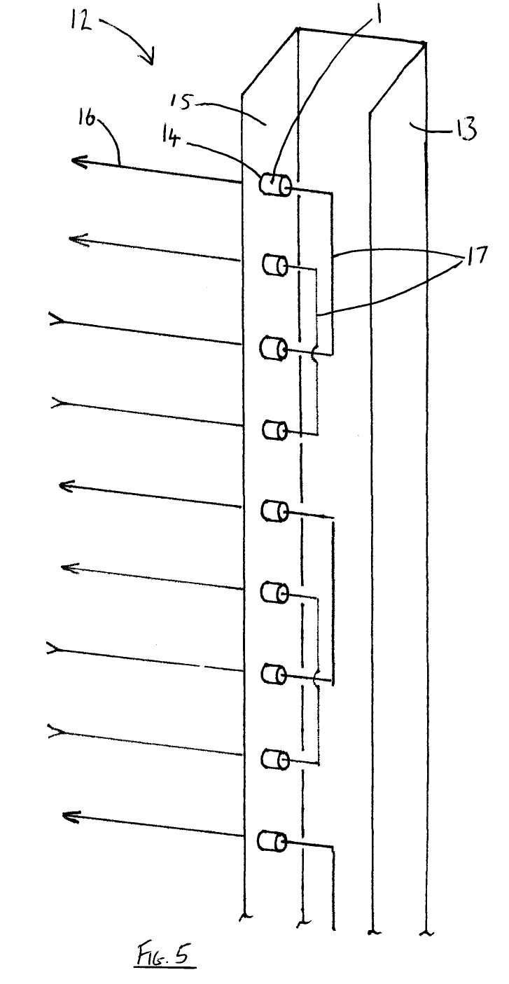

FIG. 5 shows a portion of an electric fence (12) according to an embodiment of the present invention. The electric fence (12) comprises a post (13), which may be a galvanised steel channel section post, fitted with at least one device (1), also according to the present invention, wires (16) and electrical wiring connections (17). In the embodiment shown, the first shield portion (7) of the device (1) is inserted into a hole (14) in the fence post (13), such that an engagement face (5) of the device (1) is engaged with an inside face (15) of the fence post (13). The device (1) may fit snugly in the hole (14) or can be held in engagement with the fence post (13) by tension in the wire (16). The posts (13) can be constructed as either end strain posts or as double end strain posts. They may be fitted with a cover so as to create a hollow, enclosed interior space.

In the embodiments shown in FIG. 5 the wiring (17) to create high voltage and earth circuits is inside the post (13). Thus, by arranging the device (1) such that it can be located into a (hollow) fence post (13), the complete electrical fence wiring circuits can be located inside the fence posts, leading to a reduction in installation time, greater operating security, and a reduction in the potential for damage caused by weathering. The wiring can be more complex than shown in FIG. 5 provided that the HV and earth circuits are completed. Preferably, the HV and earth wires alternate.

The spade connection (11) on the wire gripper (10) may enable rapid wiring of the electrical circuit, thereby reducing the time taken to complete the wiring connections for a conventional system.

The second shield portion (8) in the embodiment of the device (1) shown in FIG. 1 provides the necessary electrical insulation to prevent HV pulses in the wires (16) tracking through the device (1), for example along its surface to the metal of the post (13), which is earthed. The first shield portion (7), which may also be ribbed, is also designed to exceed the maximum tracking length so that earthing of the HV wire to the metal of the post (13) is prevented. Preferably, the first and second shield portions (7, 8) are arranged to insulate the post (13) from high voltages in the wires of up to about 6000-8000 volts or more. The first shield portion (7) and the second shield portion (8) may either be integral to the device (1), or they could be made in separate parts. This option allows optimisation of both the compression and solar UV resistant properties of the different sections. For example, in one embodiment, only those parts of the device (1) that are located outside the post (13) in operation (for example, the first shield portion (7)) use a material that is resistant to degradation through exposure to UV radiation, whereas in other embodiments, all of the device (1) is made from a material that is resistant to degradation through exposure to UV radiation.

According to the embodiment of the invention shown in FIG. 5, which uses the device (1) according to an embodiment of the invention shown in FIGS. 1 or 2, if any wire is cut, say by an intruder, the spring (3) returns to the uncompressed state and allows the wires (16) being held by the wire gripper (10) to earth on the post (13). The movement from the compressed to loss or uncompressed states could be used as a signal or indicator of a wire being cut or damaged, for example to assist detection of an intruder.

What is claimed is:

1. A device comprising tension means for holding an elongate element, under tension, the tension means being located inside an insulating body or housing.

2. A device according to claim 1 which additionally comprises attachment means for attaching or securing the elongate element and/or wherein the elongate element comprises a wire.

3. A device according to claim 1 which comprises one or more of:
(a) connecting means, for connecting the elongate element to an electrical or power supply or source;
(b) attachment means for securing or attaching the elongate element;
(c) tension means for subjecting the element to tension; and/or
(d) insulating means for electrically insulating the elongate element.

4. A device according to claim 1 for use in attaching a wire to, and/or insulating the wire from, a member.

5. A device according to claim 3 wherein:
(e) the insulating means is the insulating body or housing;
(f) the tension means comprises a spring; and/or
(g) the insulating means (at least partially) encloses or surrounds the attachment means and/or the tension means.

6. A device according to claim 5 wherein the insulating body or housing comprises:
an engagement face for engaging with a surface of the member; and
a passage for the wire and/or a wire gripper in the insulating body, which passage extends from the engagement face through the insulating body.

7. A device according to claim 6 wherein the tension means is for applying a tensioning force to the wire in a direction from the engagement face through said passage.

8. A device according to claim 1, wherein the tension means is a compression spring, and the elongate element and compression spring are connectable together or arranged such that the tension in the elongate element is controlled by the compression of the compression spring.

9. A device according to claim 1, wherein the tension means is a compression spring, and the elongate element and compression spring are connectable together or arranged such that an increase in compression force in the spring produces an increase in tension force in the elongate element, and an increase in tension force in the elongate element produces an increase in compression force in the spring.

10. A device according to claim 1, wherein the tension means is a compression spring, and the compression spring and the elongate element are connectable together or arranged such that the compression force in the spring is proportional to the tension force in the elongate element.

11. A device according to claim 1, wherein the tension means is a compression spring, and the compression spring and the elongate element are connectable together or arranged such that the compression force in the spring is equal to the tension force in the elongate element.

12. A device according to claim 7, wherein the tension means is a compression spring, and, in use, the elongate element and compression spring are connectable together or arranged such that movement of the end of the elongate element that is connected to the compression spring in said direction from the engagement face through said passage results in compression of the compression spring.

13. The device of claim 6, wherein the insulating body further comprises a first shield portion for surrounding a portion of said wire, which shield portion preferably extends from the engagement face in a direction which is substantially opposite to the direction of the force applied to the wire by the tension means.

14. The device of claim 2 wherein the attachment means comprises a wire gripper for gripping the wire, the wire gripper being suitably located (at least partially) in the passage in the insulating body.

15. The device of claim 14, wherein the spring applying the force to the wire applies said force through the wire gripper.

16. The device of claim 6, wherein the insulating means or body further comprises a second shield portion for at least partially surrounding said wire, spring and/or wire gripper, said second shield portion extending from the engagement face in a direction which is substantially the same as the direction of the force applied to the wire by the spring.

17. The device of claim 1, wherein the tension means is formed integrally with the insulating means or body and/or is formed of the same material.

18. The device of claim 6, wherein the tension means can in use press the engagement face of the insulating body against the surface of the member with which the engagement face is for engaging, thereby securing the device in an operating position.

19. The device of claim 6, wherein the tension means, such as a spring, is located on the same side of the engagement face as the insulating body.

20. The device of claim 16, wherein the insulating means, tension means, and optionally also the first shield portion and/or the second shield portion is/are made from an elastomeric or polymeric material.

21. A fence comprising:
at least two (e.g. substantially vertical) supporting members, optionally fence post(s); and
one or more of the devices according to claim 1.

22. The fence of claim 21 wherein the engagement face of each of the at least one devices engages with a surface surrounding one of at least one through-holes formed in the at least one or two fence post(s).

23. The fence of claim 21, further comprising a wire attached to each of the at least one devices, wherein each wire passes through one of the at least one through-holes in one of the at least one or two fence post(s), and into said passage.

24. The fence of claim 21, wherein the fence is an electric fence and further comprises:
electrical circuitry for joining the at least one of the devices, wherein;
at least one of the devices is at least partially contained or located within one of the fence posts, and
at least part of the electrical circuitry is contained within the fence posts.

25. A method of attaching an elongate element, such as wire, to a (e.g. substantially vertical) support member, optionally a (fence) post, by locating a device for gripping, tensioning and insulating the element in a hole (in the member), such that the device is engaged with or at least partly contained within the member, wherein the element and/or a element gripper or tensioner pass through or are located within the hole.

26. The method of claim 25, wherein the device is the device of claim 1.
